(19) United States
(12) Patent Application Publication
(10) Pub. No.: US 2026/0365526 A1
(43) Pub. Date: Nov. 19, 2026

(54) EMM-70 ZEOLITE COMPOSITIONS, SYNTHESES, AND USES

(71) Applicant: Exxonmobil Technology and Engineering Company, Spring, TX (US)

(72) Inventor: Trong D. PHAM, Flemington, NJ (US)

(21) Appl. No.: 18/775,609

(22) Filed: Jul. 17, 2024

Related U.S. Application Data
(63) Continuation of application No. PCT/US2023/060169, filed on Jan. 5, 2023.
(60) Provisional application No. 63/301,705, filed on Jan. 21, 2022.

(51) Int. Cl. C01B 39/48; B01J 29/70; B01J 37/00; B01J 37/04; B01J 37/08

(52) U.S. Cl. CPC C01B 39/48; B01J 29/70; B01J 37/0009; B01J 37/04; B01J 37/08; C01P 2002/72; C01P 2004/03

(57) ABSTRACT

Zeolites, designated as EMM-70, characterized by a unique powder XRD pattern, methods of making the same, and uses thereof are provided. The zeolites are described in calcined form, such as when at least part of the structure directing agent has been removed, and/or in as-synthesized form. Synthesis mixtures for forming zeolites are also described.

### CROSS REFERENCE TO RELATED APPLICATIONS

This application is a Continuation of PCT/US2023/060189 (filed Jan. 6, 2023), which claims the benefit of and priority to U.S. Provisional Application No. 63/301,705 filed Jan. 21, 2022, the disclosure of which is incorporated herein by reference.

### TECHNICAL FIELD

The present disclosure relates to zeolite compositions, methods of making the same, and uses thereof.

### BACKGROUND OF THE INVENTION

Molecular sieve materials, both natural and synthetic, may be used as adsorbents and have catalytic properties for hydrocarbon conversion reactions. Certain molecular sieves, such as zeolites, AlPOs, and mesoporous materials, are ordered, porous crystalline materials having a definite crystalline structure as determined by X-ray diffraction (XRD). Certain molecular sieves are ordered and produce specific identifiable XRD patterns. Within certain molecular sieve materials there may be a large number of cavities, which may be interconnected by a number of channels or pores. These cavities and pores are uniform in size within a specific molecular sieve material. Because the dimensions of these pores are such as to accept for adsorption molecules of certain dimensions while rejecting those of larger dimensions, these materials have come to be known as “molecular sieves” and are utilized in a variety of industrial processes, e.g., cracking, hydrocracking, disproportionation, alkylation, oligomerization, and isomerization.

Molecular sieves that find application in catalysis and adsorption include any of the naturally occurring or synthetic crystalline molecular sieves. Examples of these molecular sieves include large pore zeolites, intermediate pore size zeolites, and small pore zeolites. These zeolites and their isotypes are classified by the Structure Commission of the International Zeolite Association according to the rules of the IUPAC Commission on Zeolite Nomenclature. According to this classification, framework type zeolites and other crystalline microporous molecular sieves, for which a structure has been established, are assigned a three letter code and are described in the Ch. Baerlocher, L. B. McCusker, and D. H. Olson eds. (2007) Atlas of Zeolite Framework Types, eds. Elsevier, Sixth Edition, which is hereby incorporated by reference. These zeolites and their isotypes are also described in http://America.iza-structure.org/IZA-SC/ftc_table.php. A large pore zeolite generally has a pore size of at least about 7 Å and includes LTL, VFI (“extra-large” 18R), MAZ, FAU, OFF, *BEA, and MOR framework type zeolites. Examples of large pore zeolites include mazzite, offretite, zeolite L, VPI-5, zeolite Y, zeolite X, omega, and Beta. An intermediate pore size zeolite generally has a pore size from about 5 Å to less than about 7 Å and includes, for example, MFI, MEL, EUO, MTT, MFS, AEL, AFO, HEU, FER, MWW, and TON framework type zeolites. Examples of intermediate pore size zeolites include ZSM-5, ZSM-11, ZSM-22, MCM-22, silicalite-1, and silicalite-2. A small pore size zeolite has a pore size from about 3 Å to less than about 5.0 Å and includes, for example, CHA, RTH, ERI, KFI, LEV, SOD, and LTA framework type zeolites. Examples of small pore zeolites include ZK-4, ZSM-2, SAPO-34, SAPO-35, ZK-14, SAPO-42, ZK-21, ZK-22, ZK-5, ZK-20, zeolite A, chabazite, zeolite T, and ALPO-17.

The idealized inorganic framework structure of zeolites is a framework of silicate in which all tetrahedral atoms are connected by oxygen atoms with the four next-nearest tetrahedral atoms. The term “silicate”, as used herein, refers to a substance containing at least silicon and oxygen atoms that are alternately bonded to each other (i.e., —O—Si—O—Si—), and optionally including other atoms within the inorganic framework structure, including atoms such as boron, aluminum, or other metals (e.g., transition metals, such as titanium, vanadium, or zinc). Atoms other than silicon and oxygen in the framework silicate occupy a portion of the lattice sites otherwise occupied by silicon atoms in an ‘all-silica’ framework silicate. Thus, the term “framework silicate” as used herein refers to an atomic lattice comprising any of a silicate, borosilicate, gallosilicate, ferrisilicate, aluminosilicate, titanosilicate, zincosilicate, vanadosilicate, or the like.

The structure of the framework silicate within a given zeolite determines the size of the pores or channels that are present therein. The pore or channel size may determine the types of processes for which a given zeolite is applicable. Currently, greater than 200 unique zeolite framework silicate structures are known and recognized by the Structure Commission of the International Zeolite Association, thereby defining a range of pore geometries and orientations.

The framework silicates of zeolites are commonly characterized in terms of their ring size, wherein the ring size refers to the number of silicon atoms (or alternative atoms, such as those listed above) that are tetrahedrally coordinated with oxygen atoms in a loop to define a pore or channel within the interior of the zeolite. For example, an “8-ring” zeolite refers to a zeolite having pores or channels defined by 8 alternating tetrahedral atoms and 8 oxygen atoms in a loop. The pores or channels defined within a given zeolite may be symmetrical or asymmetrical depending upon various structural constrains that are present in the particular framework silicate.

Synthesis of molecular sieve materials typically involves hydrothermal crystallization from a synthesis mixture comprising sources of all the elements present in the zeolite such as sources of silica but also of alumina etc. In many cases a structure directing agent (SDA) is also present. Structure directing agents are compounds which are believed to promote the formation of molecular sieves and which are thought to act as templates around which certain molecular sieve structures can form and which thereby promote the formation of the desired molecular sieve. Various compounds have been used as structure directing agents including various types of quaternary ammonium cations. Typically, zeolite crystals form around structure directing agents with the structure directing agent occupying pores in the zeolite once crystallization is complete. The “as-synthesized” zeolite will therefore contain the structure directing agent in its pores so that, following crystallization, the “as-synthesized” zeolite is usually subjected to a treatment step such as a calcination step to remove the structure directing agent.

For instance, WO 2004/013042 A1 discloses the preparation of molecular sieve SSZ-64 prepared using an N-cyclobutylmethyl-N-ethylhexamethyleneiminium cation or N-cyclobutylmethyl-N-ethylheptamethyleneiminium cation structure directing agent.

Although many different zeolites have been discovered, there is a continuing need for new zeolites with desirable properties for gas separation and drying, organic conversion reactions, and other applications. New zeolites can contain novel internal pore architectures, providing enhanced selectivities in these processes. It is also important to identify new structure directing agents and more efficient methods for the synthesis of molecular sieves to facilitate the preparation of new molecular sieves and/or to reduce the cost of making known zeolites.

### SUMMARY

The present disclosure relates to zeolites, methods of making the same, and uses thereof.

In a first embodiment, the present disclosure relates to a zeolite having, in its calcined form (e.g., where at least part of the SDA has been removed), an X-ray diffraction pattern including the following peaks in degree 2-theta in Table 1:

TABLE 1

| degree 2-theta | relative intensity |
|---|---|
| (±0.20) | [100 × I/(Io)] |
| 6.64 | 60-100 |
| 7.48 | 50-70 |
| 8.42 | 40-60 |
| 14.52 | 5-15 |
| 14.97 | 5-15 |
| 21.22 | 5-15 |
| 22.60 | 60-80 |
| 25.38 | 20-30 |
| 26.61 | 0-10 |
| 28.36 | 0-5 |

In a second embodiment, the present disclosure relates to a zeolite having, in its as-synthesized form (e.g., where the SDA has not been removed), an X-ray diffraction pattern including the following peaks in degree 2-theta in Table 2:

TABLE 2

| Degree 2-theta | Relative intensity |
|---|---|
| (±0.20) | [100 × I/(Io)] |
| 6.64 | 50-70 |
| 7.49 | 50-70 |
| 8.45 | 30-50 |
| 18.05 | 5-15 |
| 21.22 | 5-15 |
| 21.56 | 0-10 |
| 22.58 | 60-100 |
| 25.36 | 20-30 |
| 26.54 | 5-15 |

In a third embodiment, the present disclosure relates to a method of making a zeolite, in particular the zeolite of the first or second embodiment, comprising the following steps: (a) preparing a synthesis mixture comprising water, a source of an oxide of tetravalent element (Y), a source of an oxide of trivalent element (X), a structure directing agent (Q), optionally a source of hydroxide ions (OH), optionally a source of alkali and/or alkaline earth metal element (M), and optionally a source of fluoride (F), wherein the structure directing agent (Q) comprises at least one cation selected from 4,5,6,7-tetrahydrobenzimidazolium cations of Formula I:

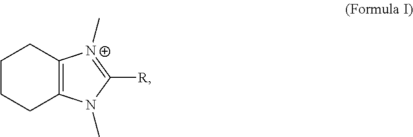

where R is methyl or ethyl, wherein the synthesis mixture has a Y/X molar ratio of less than 30 and, if a source of fluoride (F) is present, a F/Y molar ratio of less than 0.05; (b) heating said synthesis mixture under crystallization conditions including a temperature of from 100 to 200 °C for a time sufficient to form crystals of said zeolite; (c) recovering at least a portion of the zeolite from step (b); and (d) optionally treating the zeolite recovered in step (c) to remove at least part of the structure directing agent (Q).

In a fourth embodiment, the present disclosure relates to a process of converting an organic compound to a conversion product, which comprises contacting the organic compound with the zeolite according to the first or second embodiment, or prepared according to the process of the third embodiment.

These and other features and attributes of the present disclosure and their advantageous applications and/or uses will be apparent from the detailed description which follows. It will of course be appreciated that features described in relation to one aspect of the present invention may be incorporated into other aspects of the present invention. In particular, any two or more of the features described in this specification, including in this summary section, can be combined to form combinations of features not specifically described herein.

### DESCRIPTION OF THE DRAWINGS

FIG. 1 shows SEM images of the as-synthesized product of Example 2.

FIG. 2 shows the powder XRD pattern of the as-synthesized product of Example 5.

FIG. 3 shows the powder XRD pattern of the calcined product of Example 5.

FIG. 4 shows a SEM image of the as-synthesized product of Example 5.

### DETAILED DESCRIPTION

The present disclosure relates to zeolite compositions, methods of making the same, and uses thereof. Said zeolites may be designated as EMM-70 zeolites or EMM-70 materials.

In a first embodiment, the present disclosure relates to a zeolite having, in its calcined form (e.g., where at least part of the SDA has been removed), an X-ray diffraction pattern including the following peaks in degree 2-theta in Table 1:

TABLE 1

| degree 2-theta | relative intensity |
|---|---|
| (±0.20) | [100 × I/(Io)] |
| 6.64 | 60-100 |
| 7.48 | 50-70 |
| 8.42 | 40-60 |
| 14.52 | 5-15 |
| 14.97 | 5-15 |
| 21.22 | 5-15 |
| 22.60 | 60-80 |
| 25.38 | 20-30 |
| 26.61 | 0-10 |
| 28.36 | 0-5 |

In a further embodiment, said zeolite, in its calcined form, may have an X-ray diffraction pattern including the following peaks in degree 2-theta in Table 1A, wherein the d-spacing values have a deviation determined based on the corresponding deviation ±0.20 degree 2-theta when converted to the corresponding values for d-spacing using Bragg's law:

TABLE 1A

| degree 2-theta | d-spacing | relative intensity |
|---|---|---|
| (±0.20) | (Å) | [100 × I/(Io)] |
| 6.64 | 13.30 | 60-100 |
| 7.48 | 11.82 | 50-70 |
| 8.42 | 10.49 | 40-60 |
| 14.52 | 6.10 | 5-15 |
| 14.97 | 5.91 | 5-15 |
| 21.22 | 4.18 | 5-15 |
| 22.60 | 3.93 | 60-80 |
| 25.38 | 3.51 | 20-30 |
| 26.61 | 3.34 | 0-10 |
| 28.36 | 3.14 | 0-5 |

The XRD patterns with the XRD peaks described herein use Cu(K_{α}) radiation.

In one or more further embodiments, said zeolite, in its calcined form, may have a micropore volume of 0.05 to 0.3, such as 0.1 to 0.25, e.g., 0.18 cc/g.

In one or more further embodiments, said zeolite, in its calcined form, may have micropore surface area of 100 to 800 m²/g, such as from 300 to 600 m²/g, e.g., 505 m²/g, and/or an external surface area of 5 to 200 m²/g, such as from 20 to 100 m²/g, e.g., 63 m²/g.

In one or more further embodiments, said zeolite, in its calcined form, may be optionally represented by the molecular formula of Formula II:

(m)X₂O₃:YO₂ (Formula II),

wherein 0.017≤m≤0.1, X is a trivalent element, and Y is a tetravalent element. Y may comprise one or more of Si and Ge. For example, Y may comprise or be Si. X may comprise one or more of Al and B. For example, X may comprise or be Al and/or B, in particular X may comprise or be Al. The oxygen atoms in Formula II may be replaced by carbon atoms (e.g., in the form of CH₂), which can come from sources of the components used to prepare the as-made zeolite. The oxygen atoms in Formula II can also be replaced by nitrogen atoms, e.g., after the SDA has been removed. Formula II can represent the framework of a typical zeolite as defined in the present disclosure, in its calcined form, and is not meant to be the sole representation of said zeolite. Said zeolite, in its calcined form, may contain SDA and/or impurities after appropriate treatments to remove the SDA and impurities, which are not accounted for in Formula II. Further, Formula II does not include the protons and charge compensating ions that may be present in the calcined zeolite.

The variable m represents the molar ratio relationship of X₂O₃ to YO₂ in Formula II. For example, when m is 0.025, the molar ratio of YO₂ to X₂O₃ is 40 and the molar ratio of Y to X is 20 (e.g., the molar ratio of Si/Al is 20). m may vary from 0.017 to 0.1, such as at least 0.017, or at least 0.020, or at least 0.025 to at most 0.1, or at most 0.05, e.g., 0.033. The molar ratio of Y to X may be 1 to less than 30, such as at least 5, or at least 10, and up to 29, or up to 25, or up to 20, e.g., 15.

In a second embodiment, the present disclosure relates to a zeolite, in particular a zeolite as defined in the first embodiment, having in its as-synthesized form (e.g., where the SDA has not been removed) an X-ray diffraction pattern including the following peaks in degree 2-theta in Table 2:

TABLE 2

| Degree 2-theta | Relative intensity |
|---|---|
| (±0.20) | [100 × I/(Io)] |
| 6.64 | 50-70 |
| 7.49 | 50-70 |
| 8.45 | 30-50 |
| 18.05 | 5-15 |
| 21.22 | 5-15 |
| 21.56 | 0-10 |
| 22.58 | 60-100 |
| 25.36 | 20-30 |
| 26.54 | 5-15 |

In a further embodiment, said zeolite, in its as-synthesized form, may have an X-ray diffraction pattern including the following peaks in degree 2-theta in Table 2A, wherein the d-spacing values have a deviation determined based on the corresponding deviation ±0.20 degree 2-theta when converted to the corresponding values for d-spacing using Bragg's law:

TABLE 2A

| degree 2-theta | d-spacing | relative intensity |
|---|---|---|
| (±0.20) | (Å) | [100 × I/(Io)] |
| 6.64 | 13.31 | 50-70 |
| 7.49 | 11.79 | 50-70 |
| 8.45 | 10.45 | 30-50 |
| 18.05 | 4.91 | 5-15 |
| 21.22 | 4.18 | 5-15 |
| 21.56 | 4.12 | 0-10 |
| 22.58 | 3.93 | 60-100 |
| 25.36 | 3.51 | 20-30 |
| 26.54 | 3.36 | 5-15 |

The XRD patterns with the XRD peaks described herein use Cu(K_{α}) radiation.

In one or more further embodiments, said zeolite, in its as-synthesized form, may be optionally represented by the molecular formula of Formula III:

(q)Q:(m)X₂O₃:YO₂ (Formula III),

wherein 0≤q≤0.5, 0.017<m≤0.1, comprises at least one cation selected from 4,5,6,7-tetrahydrobenzimidazolium cations of Formula I:

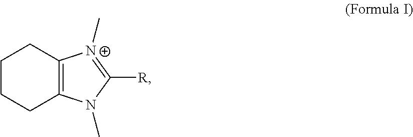

where R is methyl or ethyl; X is a trivalent element as defined for Formula II, and Y is a tetravalent element as defined for Formula II. Formula III can represent the framework of a typical zeolite as defined in the present disclosure, in its as-synthesized form, therefore containing structure directing agent (Q), and is not meant to be the sole representation of such material. Said zeolite, in its as-synthesized form, may contain impurities which are not accounted for in Formula III. Further, Formula III does not include the protons and charge compensating ions that may be present in said as-synthesized zeolite.

The variable m represents the molar ratio relationship of X₂O₃ to YO₂ in Formula III. The values for variable m in Formula III are the same as those described herein for Formula II.

The variable n represents the molar relationship of Q to YO₂ in Formula III. For example, when n is 0.1, the molar ratio of Q to YO₂ is 0.1. The molar ratio of Q to YO₂ may be from 0 to 0.5, such as from 0.02 to 0.4, e.g., 0.05 to 0.3.

In a third embodiment, the present disclosure relates to a method of making a zeolite, in particular a zeolite as defined in the first or second embodiment, e.g., EMM-70, comprising the following steps:
(a) preparing a synthesis mixture comprising water, a source of an oxide of tetravalent element (Y), a source of an oxide of trivalent element (X), a structure directing agent (Q), optionally a source of hydroxide ions (OH), and optionally a source of alkali and/or alkaline earth metal element (M),
   wherein the structure directing agent (Q) comprises at least a tetrahydrobenzimidazolium cation of Formula I:

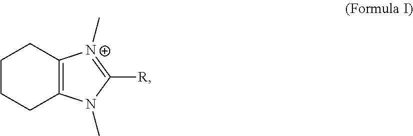

where R is methyl or ethyl,
wherein the synthesis mixture has a Y/X molar ratio of less than 30 and, if a source of fluoride (F) is present, a F/Y molar ratio of less than 0.05;
(b) heating said synthesis mixture under crystallization conditions including a temperature of from 100 °C to 200 °C for a time sufficient to form crystals of said zeolite;
(c) recovering at least a portion of the zeolite from step (b); and
(d) optionally treating the zeolite recovered in step (c) to remove at least part of the structure directing agent (Q).

The structure directing agent (Q) comprises at least one cation selected from the group consisting of 1,2,3-trimethyl-4,5,6,7-tetrahydrobenzimidazolium cation, 2-ethyl-1,3-dimethyl-4,5,6,7-tetrahydrobenzimidazolium cation, and mixtures thereof. The structure directing agent (Q) may be present in any suitable form, for example as a halide, such as a fluoride, a chloride, an iodide or a bromide, as a hydroxide or as a nitrate, for instance in its hydroxide form. The structure directing agent (Q) may be present in the synthesis mixture in a Q/Y molar ratio of 0.05 to 1.0, such as at least 0.1, or at least 0.15, or at least 0.2, up to at most 0.8, or at most 0.7, or at most 0.6, for instance 0.1 to 0.8, or 0.15 to 0.5, e.g., 0.2 to 0.4.

The synthesis mixture comprises at least one source of an oxide of tetravalent element Y such as Si and/or Ge, preferably Y comprising Si, and more preferably Y being Si. Suitable sources of tetravalent element Y that can be used to prepare the synthesis mixture depend on the element Y that is selected. In embodiments where Y is silicon, Si sources (e.g., silicon oxide sources) suitable for use in the method include silicates, e.g., tetraalkyl orthosilicates such as tetramethylorthosilicate (TMOS) and tetraethylorthosilicate (TEOS), fumed silica such as Aerosil® (available from Evonik), Cabosperse® (available from Cabot) and Cabosil® (available from DMS), precipitated silica such as Ultrasil® and Sipernat® 340 (available from Evonik), alkali metal silicates such as potassium silicate and sodium silicate, and aqueous colloidal suspensions of silica, for example, that sold by E.I. du Pont de Nemours under the tradename Ludox® or that sold by Evonik under the tradename Aerodisp®; preferably silicates, fumed silica, precipitated silica, alkali metal silicates, and colloidal silica.

In embodiments where Y is germanium, suitable Ge sources include germanium oxide. The synthesis mixture comprises at least one source of an oxide of trivalent element X such as Al and/or B, preferably X comprising Al and/or B, e.g., Al, and more preferably X being Al and/or B, e.g., Al. Suitable sources of trivalent element X that can be used to prepare the synthesis mixture depend on the element X that is selected. In embodiments where X is aluminum, Al sources (e.g., aluminum oxide sources) suitable for use in the method include aluminum salts, especially water-soluble salts, such as aluminum sulfate, aluminum nitrate, aluminum hydroxide, alkali metal aluminates such as sodium aluminate, and aluminum alkoxides such as aluminum isopropoxide, as well as hydrated aluminum oxides, such as boehmite, gibbsite, and pseudoboehmite, and mixtures thereof. Other aluminum sources include, but are not limited to, other water-soluble aluminum salts, sodium aluminate, aluminum alkoxides, such as aluminum isopropoxide, or aluminum metal, such as aluminum in the form of chips. Especially suitable sources of alumina are water-soluble salts, such as aluminum sulfate, aluminum nitrate, aluminum hydroxide, and alkali metal aluminates such as sodium aluminate and potassium aluminate. In embodiments where X is boron, suitable B sources include boric acid and borate salts such as sodium tetraborate or borax and potassium tetraborate. Sources of boron tend to be more soluble than sources of aluminum in hydroxide-mediated synthesis systems.

Alternatively or in addition to previously mentioned sources of Y and X, sources containing both Y and X elements can also be used, such as sources of Si and Al. Examples of suitable sources containing both Si and Al elements include amorphous silica-alumina gels or dried silica alumina powders, silica aluminas, clays, such as kaolin, metakaolin, and zeolites, in particular aluminosilicates such as synthetic faujasite and ultrastable faujasite, for instance Ultrastable Y (USY), beta or other large to medium pore zeolites.

The synthesis mixture may have a Y/X molar ratio from 1 to less than 30, such as 5 to 25, for instance 5 or 10 to 20, e.g., 15.

In a preferred embodiment, Y is Si, X is Al, and the zeolite is an aluminosilicate. In another preferred embodiment, Y is Si, X is B, and the zeolite is a borosilicate.

Optionally, the synthesis mixture may comprise one or more sources of alkali or alkaline earth metal cation (M). M is preferably selected from the group consisting of sodium, potassium, lithium, rubidium, calcium, magnesium and mixtures thereof, preferably sodium and/or potassium, more preferably sodium. The sodium source, when present, may be sodium hydroxide, sodium aluminate, sodium silicate, sodium aluminate or sodium salts such as NaCl, NaBr or sodium nitrate. The potassium source, when present, may be potassium hydroxide, potassium aluminate, potassium silicate, a potassium salt such as KCl or KBr or potassium nitrate. The lithium source, when present, may be lithium hydroxide or lithium salts such as LiCl, LiBr, Lil, lithium nitrate, or lithium sulfate. The rubidium source, when present, may be rubidium hydroxide or rubidium salts such as RbCl, RbBr, RBI, or rubidium nitrate. The calcium source, when present, may be calcium hydroxide, for example. The magnesium source, when present, may be magnesium hydroxide, for example. The alkali or alkaline earth metal cation M may also be present in the one or more sources of a trivalent element X, such as sodium aluminate, sodium tetraborate, potassium tetraborate, and/or in the one or more sources of tetravalent element Y, such as potassium silicate and/or sodium silicate. The synthesis mixture may comprise the alkali or alkaline earth metal cation (M) source in a M/Y molar ratio of 0 to 1.0, such as 0.05 to 0.5, e.g., from 0.05 to less than 0.1. Alternatively, the synthesis mixture may be substantially free from an alkali or alkaline earth metal cation (M).

Optionally, the synthesis mixture may also contain at least one source of hydroxide ions (OH). For example, hydroxide ions can be present as a counter ion of the structure directing agent (Q) or by the use of aluminum hydroxide as a source of Al. Suitable sources of hydroxide ions can also be selected from the group consisting of alkali metal hydroxides, alkaline earth metal hydroxides, ammonium hydroxide, and mixtures thereof; such as from sodium hydroxide, potassium hydroxide, lithium hydroxide, rubidium hydroxide, calcium hydroxide, magnesium hydroxide, ammonium hydroxide, and mixtures thereof; more often sodium hydroxide, potassium hydroxide, lithium hydroxide, ammonium hydroxide, and mixtures thereof; most often sodium hydroxide and/or potassium hydroxide. The synthesis mixture may comprise the hydroxide ions source in a OH/Y molar ratio of from 0 to 1.0, such as 0.05 to 0.8, for instance 0.1 to 0.6 or 0.15 to 0.5, e.g., from 0.2 to 0.5. Alternatively, the synthesis mixture may be substantially free from a hydroxide source.

The synthesis mixture used for the preparation of EMM-70 material comprises fluoride ions (F) in a F/Si molar ratio of less than 0.05, such as 0 to less than 0.04, or 0 to 0.02, or 0 to 0.01, e.g., 0. In particular, the synthesis mixture used for the preparation of EMM-70 zeolite is substantially free of fluoride ions (F). This means that no source of fluoride ions is added to the synthesis mixture in any substantial amount, e.g., the synthesis mixture has a F/Si molar ratio of less than 0.05, such as less than 0.02, less than 0.01 or even less than 0.005, e.g., 0. Said fluoride ions (F), if present, may originate from any compound capable of releasing fluoride ions in the molecular sieve synthesis mixture, such as hydrogen fluoride (HF); salts containing one or several fluoride ions, such as metal fluoride, preferably where the metal is sodium, potassium, calcium, magnesium, strontium or barium; ammonium fluoride (NH₄F); and ammonium bifluoride (NH₄HF₂). Small amounts of fluoride ions (F) may also be present as impurities, for instance in the optional source of alkali or alkaline earth metal cation (M).

The synthesis mixture may optionally further contain at least one source of halide ions (W), different from fluoride ions, which may be selected from the group consisting of chloride, bromide or iodide. The source of halide ions (W) may be any compound capable of releasing halide ions in the molecular sieve synthesis mixture. For instance, halide ions can be present as a counter ion of the structure directing agent (Q). Non-limiting examples of sources of halide ions include hydrogen chloride, ammonium chloride, hydrogen bromide, ammonium bromide, hydrogen iodide, and ammonium iodide; salts containing one or several halide ions, such as metal halides, preferably where the metal is sodium, potassium, calcium, magnesium, strontium or barium; ammonium halides; or tetraalkylammonium halides such as tetramethylammonium halides or tetraethylammonium halides. Small amounts of halide ions (W) may also be present as impurities, for instance in the optional source of alkali or alkaline earth metal cation (M). The halide ions (W) may be present in a W/Y molar ratio of 0 to 0.2, such as 0 to 0.1, for instance less than 0.1 or even 0. In a preferred embodiment, the synthesis mixture may be substantially free from halide ions (W).

The synthesis may be performed with our without added nucleating seeds. If nucleating seeds are added to the synthesis mixture, the seeds may be of the same or of a different structure than the zeolite of the present disclosure, or EMM-70 material, from a previous synthesis, and may suitably present in an amount from about 0.01 ppm by weight to about 10,000 ppm by weight, based on the synthesis mixture, such as from about 100 ppm by weight to about 5,000 ppm by weight of the synthesis mixture.

The synthesis mixture typically comprises water in a H₂O/Y molar ratio of from 1 to 100, such as 10 to 80 or 15 to 50, for instance 20 to 40, e.g., 25 or 30. Depending on the nature of the components in the base mixture, the amount of solvent (e.g., water from the hydroxide solution, and optionally methanol and ethanol from the hydrolysis of silica sources) of the base mixture may be removed such that a desired solvent to Y molar ratio is achieved for the synthesis mixture. Suitable methods for reducing the solvent content may include evaporation under a static or flowing atmosphere such as ambient air, dry nitrogen, dry air, or by spray drying or freeze drying. Water may be added to the resulting mixture to achieve a desired H₂O/Y molar ratio when too much water is removed during the solvent removal process. In some examples, water removal is not necessary when the preparation have sufficient H₂O/Y molar ratio.

Carbon in the form of CH₂ may be present in the various sources of components used to prepare the zeolite of the present disclosure, e.g., tetravalent element source (silica source) or trivalent element source (alumina source), and incorporated into the zeolite framework as bridging atoms. Nitrogen atoms may be incorporated into the framework of the zeolite framework as bridging atoms after the SDA has been removed.

In one or more aspects, the synthesis mixture after solvent adjustment (e.g., where the desired water to silica ratio is achieved) may be mixed by a mechanical process such as stirring or high shear blending to assure suitable homogenization of the base mixture, for example, using dual asymmetric centrifugal mixing (e.g., a FlackTek speedmixer) with a mixing speed of 1,000 to 3,000 rpm (e.g., 2000 rpm).

The synthesis mixture is then subject to crystallization conditions suitable for the zeolite to form. Crystallization of the zeolite may be carried out under static or stirred conditions in a suitable reactor vessel, such as for example Teflon® lined or stainless steel autoclaves placed in a convection oven maintained at an appropriate temperature.

The crystallization in step (b) of the method is typically carried out at a temperature of 100 °C to 200 °C, such as 150 °C to 170 °C, for a time sufficient for crystallization to occur at the temperature used. For instance, at higher temperatures, the crystallization time may be reduced. For instance, the crystallization conditions in step (b) of the method may include heating for a period of from 1 to 100 days, such as from 1 to 50 days, for example from 10 or 20 to 40 days. The crystallization time can be established by methods known in the art such as by sampling the synthesis mixture at various times and determining the yield and X-ray crystallinity of precipitated solid. Unless indicated otherwise herein, the temperature measured is the temperature of the surrounding environment of the material being heated, for example the temperature of the atmosphere in which the material is heated.

Typically, the zeolite is formed in solution and can be recovered by standard means, such as by centrifugation or filtration. The separated zeolite can also be washed, recovered by centrifugation or filtration and dried.

The zeolite of the present disclosure, when employed either as an adsorbent or as a catalyst in an organic compound conversion process may be dehydrated (e.g., dried) at least partially. This can be done by heating to a temperature in the range of 80 °C to 500 °C, such as 90 °C to 370 °C in an atmosphere such as air, nitrogen, etc., and at atmospheric, subatmospheric or superatmospheric pressures for between 30 minutes and 48 hours. Dehydration may also be performed at room temperature merely by placing the molecular sieve in a vacuum, but a longer time is required to obtain a sufficient amount of dehydration.

As a result of the crystallization process, the recovered product contains within its pores at least a portion of the structure directing agent used in the synthesis. The as-synthesized zeolite recovered from step (c) may thus be subjected to thermal treatment or other treatment to remove part or all of the SDA incorporated into its pores during the synthesis. Thermal treatment (e.g., calcination) of the as-synthesized zeolite typically exposes the materials to high temperatures sufficient to remove part or all of the SDA, in an atmosphere selected from air, nitrogen, ozone or a mixture thereof in a furnace. While subatmospheric pressure may be employed for the thermal treatment, atmospheric pressure is desired for reasons of convenience. The thermal treatment may be performed at a temperature up to 925 °C e.g., 300 °C to 700 °C or 400 °C to 600 °C. The temperature measured is the temperature of the surrounding environment of the sample. The thermal treatment (e.g., calcination) may be carried out in a box furnace in dry air, which has been exposed to a drying tube containing drying agents that remove water from the air. The heating is usually calcined for at least 1 minute and generally no longer than 1 or at most a few days. The heating may first be carried out under a nitrogen atmosphere and then the atmosphere may be switched to air and/or ozone.

The zeolite may also be subjected to an ion-exchange treatment, for example, with aqueous ammonium salts, such as ammonium nitrates, ammonium chlorides, and ammonium acetates, in order to remove remaining alkali metal cations and/or alkaline earth metal cations and to replace them with protons thereby producing the acid form of the molecular sieve. To the extent desired, the original cations of the as-synthesized material, such as alkali metal cations, can be replaced by ion exchange with other cations. Preferred replacing cations can include hydrogen ions, hydrogen precursor, e.g., ammonium ions and mixtures thereof. The ion exchange step may take place after the as-made molecular sieve is dried. The ion-exchange step may take place either before or after a calcination step.

Optionally, in embodiments where the zeolite comprises boron atoms, e.g., when the zeolite is a borosilicate, aluminum atoms may be introduced in the zeolite framework (wherein part or all of the SDA has been removed) during an exchange process following the hydrothermal synthesis reaction. Such exchange process may comprise exposing the zeolite to an aluminum source such as an aqueous solution comprising an aluminum salt, under conditions sufficient to exchange at least a portion and up to substantially all of the boron atoms in the framework silicate with aluminum atoms. For example, a calcined borosilicate zeolite may be converted to an aluminosilicate by heating the calcined zeolite comprising boron with a solution of aluminum sulfate, aluminum nitrate, aluminum chloride and/or aluminum acetate (e.g., in a sealed autoclave in a convention oven at 100 °C or at boiling temperature in an open system). The aluminum treated zeolite may then be recovered by filtration and washed with deionized water.

The zeolite may also be subjected to other treatments such as steaming and/or washing with solvent. Such treatments are well-known to the skilled person and are carried out in order to modify the properties of the molecular sieve as desired.

The zeolite of the present disclosure, where part or all of the SDA has been removed, may be used as an adsorbent or as a catalyst or support for catalyst in a wide variety of hydrocarbon conversions, e.g., conversion of organic compounds to a converted product.

The zeolite of the present disclosure (where part or all of the SDA is removed) may be used as an adsorbent, such as for separating at least one component from a mixture of components in the vapor or liquid phase having differential sorption characteristics with respect to the material. Therefore, at least one component can be partially or substantially totally separated from a mixture of components having differential sorption characteristics with respect to the zeolite by contacting the mixture with said zeolite to selectively sorb the one component. For instance, in a process for selectively separating one or more desired components of a feedstock from remaining components of the feedstock, the feedstock may be contacted with a sorbent that comprises the zeolite of the present disclosure at effective sorption conditions, thereby forming a sorbed product and an effluent product. One or more of the desired components are recovered from either the sorbed product or the effluent product.

The zeolite of the present disclosure (where part or all of the SDA is removed) may also be used as a catalyst to catalyze a wide variety of organic compound conversion processes. Examples of chemical conversion processes, which are effectively catalyzed by the zeolite described herein, either alone or in combination with one or more other catalytically active substances including other crystalline catalysts, include those requiring a catalyst with acid activity. Examples of organic conversion processes, which may be catalyzed by the zeolite described herein include cracking, hydrocracking, isomerization, polymerisation, reforming, hydrogenation, dehydrogenation, dewaxing, hydrodewaxing, adsorption, alkylation, transalkylation, dealkylation, hydrodecylization, disproportionation, oligomerization, dehydrocyclization/cracking, hydrocracking, isomerization, polymerisation, reforming, hydrogenation, dehydrogenation, dewaxing, hydrodewaxing, adsorption, alkylation, transalkylation, dealkylation, hydrodecylization, disproportionation, oligomerization, dehydrocyclization, conversion methanol to olefins, deNOx applications, and combinations thereof. The conversion of hydrocarbon feeds can take place in any convenient mode, for example in fluidized bed, moving bed, or fixed bed reactors depending on the types of process desired.

The zeolite of the present disclosure may be formulated into product compositions by combination with other materials, such as binders and/or matrix materials that provide additional hardness to the finished product. These other materials can be inert or catalytically active materials.

For instance, it may be desirable to incorporate the zeolite of the present disclosure of the present invention with another material that is resistant to the temperatures and other conditions employed during use. Such materials include synthetic or naturally occurring zeolites as well as inorganic materials such as clays, silica and/or metal oxides such as alumina and mixtures thereof. The metal oxides may be either naturally occurring or in the form of gelatinous precipitates or gels including mixtures of silica and metal oxides. Use of a resistant material in conjunction with the zeolite of the present disclosure, i.e., combined therewith or present during synthesis of the as-made zeolite, which crystal is active, tends to change the conversion and/or selectivity of the catalyst in certain organic conversion processes. Inactive resistant materials suitably serve as diluents to control the amount of conversion in a given process so that products can be obtained in an economic and orderly manner without employing other means for controlling the rate of reaction. These materials may be incorporated into naturally occurring clays, e.g., bentonite and kaolin, to improve the crush strength of the product under commercial operating conditions. Said inactive resistant materials, i.e., clays, oxides, etc., function as binders for the catalyst. A catalyst having good crush strength can be beneficial because in commercial use, it is desirable to prevent the catalyst from breaking down into powder-like materials.

Naturally occurring clays which may be used include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays can be used in the raw state as originally mined or after being subjected to calcination, acid treatment or chemical modification. Binders useful for compositing with the zeolite of the present disclosure also include inorganic oxides selected from silica, zirconia, titania, magnesia, beryllia, alumina, yttria, gallium oxide, zinc oxide and mixtures thereof.

In addition to the foregoing materials, the zeolite of the present disclosure may be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

These binder materials are resistant to the temperatures and other conditions, e.g., mechanical attrition, which occur in various hydrocarbon separation processes. Thus the zeolite of the present disclosure may be used in the form of an extrudate with a binder. They are typically bound by forming a pill, sphere, or extrudate. The extrudate is usually formed by extruding the molecular sieve, optionally in the presence of a binder, and drying and calcining the resulting extrudate. Further treatments such as steaming, and/or ion exchange may be carried out as required. The molecular sieve may optionally be bound with a binder having a surface area of at least 100 m²/g, for instance at least 200 m²/g, optionally at least 300 m²/g.

The relative proportions of molecular sieve and inorganic oxide matrix may vary widely, with the molecular sieve content ranging from about 1 to about 100 percent by weight and more usually, particularly when the composite is prepared in the form of extrudates, in the range of about 2 to about 95, optionally from about 20 to about 90 weight percent of the composite.

The zeolite of the present disclosure may also be used in intimate combination with a hydrogenating component such as tungsten, vanadium, molybdenum, rhenium, nickel, cobalt, chromium, manganese, or a noble metal such as platinum or palladium where a hydrogenation-dehydrogenation function is to be performed. Such hydrogenating components may be incorporated in the composition by way of one or more of the following processes: cocrystallization; exchanged into the composition to the extent a Group IIIA element, e.g., aluminum, is in the structure; or intimately physically admixed therewith. Such components can also be impregnated in or onto the zeolite, for example, by treating the molecular sieve with a hydrogenating metal-containing ion. For instance, in the case of platinum, suitable platinum compounds for this purpose include chloroplatinic acid, platinous chloride and various compounds containing a platinum amine complex. Combinations of metals and methods for their introduction can also be used.

It will be understood by a person skilled in the art that the zeolite of the present disclosure may contain impurities, such as amorphous materials, unit cells having different topologies (e.g., quartz or molecular sieves of different framework type, that may or may not impact the performance of the resulting catalyst), and/or other impurities (e.g., heavy metals and/or organic hydrocarbons). Typical examples of molecular sieves of different framework type co-existing with the zeolite of the present disclosure are e.g., molecular sieves of FAU or IWV framework type, such as faujasite and ITQ-27. The zeolite of the present disclosure is preferably substantially free of impurities. The term “substantially free of impurities” (or in the alternative “substantially pure”) used herein means the zeolite contains a minor proportion (less than 50 wt %), preferably less than 20 wt %, more preferably less than 10 wt %, even more preferably less than 5 wt % and most preferably less than 1 wt % (e.g., less than 0.5 wt % or 0.1 wt %), of such impurities (e.g., “non-EMM-70 material”), which weight percent (wt %) values are based on the combined weight of impurities and pure zeolite. The amount of impurities can be appropriately determined by powder XRD, rotating electron diffraction, and/or SEM/TEM (e.g., different crystal morphologies).

The zeolite described herein are substantially crystalline. As used herein, the term “crystalline” refers to a crystalline solid form of a material, including, but not limited to, a single-component or multiple-component crystal form, e.g., including solvates, hydrates, and a co-crystal. Crystalline can mean having a regularly repeating and/or ordered arrangement of molecules, and possessing a distinguishable crystal lattice. For example, the zeolite can have different water or solvent content. The different crystalline lattices can be identified by solid state characterization methods such as by XRD (e.g., powder XRD). Other characterization methods known to a person of ordinary skill in the relevant art can further help identify the crystalline form as well as help determine stability and solvent/water content. As used herein, the term “substantially crystalline” means a majority (greater than 50 wt %) of the weight of a sample of a material described is crystalline and the remainder of the sample is a non-crystalline form. In one or more aspects, a substantially crystalline sample has at least 95% crystallinity (e.g., 5% of the non-crystalline form), at least 96% crystallinity (e.g., 4% of the non-crystalline form), at least 97% crystallinity (e.g., 3% of the non-crystalline form), at least 98% crystallinity (e.g., about 2% of the non-crystalline form), at least 99% crystallinity (e.g., 1% of the non-crystalline form), and 100% crystallinity (e.g., 0% of the non-crystalline form).

Aspects of the disclosure are described in greater detail by way of specific examples. The following examples are offered for illustrative purposes, and are not intended to limit the disclosure in any manner. Those of skill in the relevant art will readily recognize a variety of parameters can be changed or modified to yield essentially the same results.

### Examples

The present invention is further illustrated below without limiting the scope thereto.

In these examples, the X-ray diffraction (XRD) patterns of the as-synthesized and calcined materials were recorded on an X-Ray Powder Diffractometer (Bruker Da Vinci D8 Discovery instrument) in continuous mode using a Cu Kα radiation, Bragg-Bentano geometry with Vantec 500 detector, in the 2θ range of 2 to 50 degrees. The interplanar spacings, d-spacings, were calculated in Angstrom units, and the relative intensities of the lines, I/I_{O} is the ratio of the peak intensity to that of the intensity of the strongest line, above background. The intensities are uncorrected for Lorentz and polarization effects. The location of the diffraction peaks in 2-theta, and the relative peak area intensities of the lines, I/I (o), where Io is the intensity of the strongest line, above background, were determined with the MDI Jade peak search algorithm. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history.

The scanning electron microscopy (SEM) images of the as-synthesized materials were obtained on a Hitachi 4800 Scanning Electron Microscope. SEM images were used to aid assessment of product purity. The presence of obviously different crystal morphologies in a SEM image can be an indication of impurities in the form of other crystalline materials. Such an approximate analysis can be especially useful in identifying the presence of formation of relatively minor amounts of crystalline impurities which may not be identifiable on product XRD patterns.

The overall BET surface area (SBET) of the materials was determined by the BET method as described by S. Brunauer, et al. (1938) J. Am. Chem. Soc., v.60, pg. 309, incorporated herein by reference, using nitrogen adsorption-desorption at liquid nitrogen temperature. The external surface area (Sₑₓₜ) of the material was obtained from the t-plot method, and the micropore surface area (S_{micro}) of the material was calculated by subtracting the external surface area (Sₑₓₜ) from the overall BET surface area (SBET).

The micropore volume (V_{micro}) of the materials can be determined using methods known in the relevant art. For example, the micropore volume of the materials can be measured with nitrogen physisorption, and the data can be analyzed by the t-plot method described in Lippens, B. C. et al. (1965) “Studies on pore system in catalysts: V. The t method,” J. Catal., v.4, pg. 319, which describes micropore volume method and is incorporated herein by reference.

The molar ratios and conditions used for the syntheses of Examples 2-7, as well as the resulting products, are detailed below and summarized in Table 3.

### Example 1a: Synthesis of 1,2,3-trimethyl-4,5,6,7-tetrahydro-1H-benzo[d]imidazol-3-ium cation (SDA-1)

2-Methyl-4,5,6,7-tetrahydro-1H-benzimidazole: 40 g of 2-methylbenzimidazole were dissolved in 320 ml glacial acid. 15 g of palladium (10 wt % on carbon) were added and the reaction mixture was treated with hydrogen at a temperature of 120 °C and under a pressure of 80 bar for 24 hours. The solution was filtrated over celite and washed with glacial acid. The solvent was evaporated under vacuum, then sodium hydroxide solution was added to bring the solution to a pH of 9-10. The precipitate was filtrated and washed with water then dissolved in chloroform and extracted with saturated sodium chloride solution. The organic phase was dried over sodium sulfate, filtrated and concentrated under vacuum.

1,2,3-Trimethyl-4,5,6,7-tetrahydro-1H-benzo[d]imidazol-3-ium iodide: 13.6 g of 2-methyl-4,5,6,7-tetrahydro-1H-benzimidazole, 70 g of iodomethane and 27 g of potassium carbonate were added into 150 ml acetonitrile (CH₃CN) in a 250 mL round-bottom flask equipped with a magnetic stir bar. The suspension was subsequently refluxed for 18 hours, then cooled to room temperature. The solution was then filtered through a Buchner funnel, and the filtrate solution was concentrated by a rotovap. Dicholoromethane was added to the concentrated solution to remove the leftover potassium salts. The filtrate in dichloromethane was concentrated by a rotovap and dried under vacuum to obtain 1,2,3-trimethyl-4,5,6,7-tetrahydro-1H-benzo[d]imidazol-3-ium iodide.

1,2,3-Trimethyl-4,5,6,7-tetrahydro-1H-benzo[d]imidazol-3-ium hydroxide: The iodide salt was ion-exchanged with ion-exchange resin Amberlite® IRN78 OH hydroxide form (with iodide: resin: water ratio of 1:3.5:5) to the hydroxide form. The exchange was performed at room temperature overnight.

### Example 1b: Synthesis of 2-ethyl-1,3-dimethyl-4,5,6,7-tetrahydro-1H-benzo[d]imidazol-3-ium cation (SDA-2)

The three-step process of Example 1a was followed, except that 2-methylbenzimidazole was replaced with 2-ethylbenzimidazole.

### Example 2: SDA-1, USY Zeolite, Si/Al=15

In a PTFE liner for a 23 mL Steel Parr autoclave, the following were mixed together: 2.87 g of SDA-1 solution (13.9 wt %), 0.72 g of NaOH solution (4 wt %), 2.16 g deionized water, and 0.190 g of Ultrastable Y (USY) zeolite with a Si/Al molar ratio of 15 (available from Zeolyst as CBV720) to produce a synthesis mixture having the following composition in terms of molar ratios:

25H₂O:1SiO₂:0.033Al₂O₃:0.23QOH:0.07NaOH.

The liner was then capped, sealed within a 23 mL Parr autoclave, and placed within a spit inside of a convection over. The reactor was heated at 160 °C for 6 weeks under tumbling conditions (about 30 rpm). The product was isolated by filtration, rinsed with deionized water and dried. The as-synthesized material was then calcined to 580 °C in air within a box furnace with a ramping rate of 3 °C/minute. The temperature remained at 580 °C for 8 hours and then the box furnace was allowed to cool.

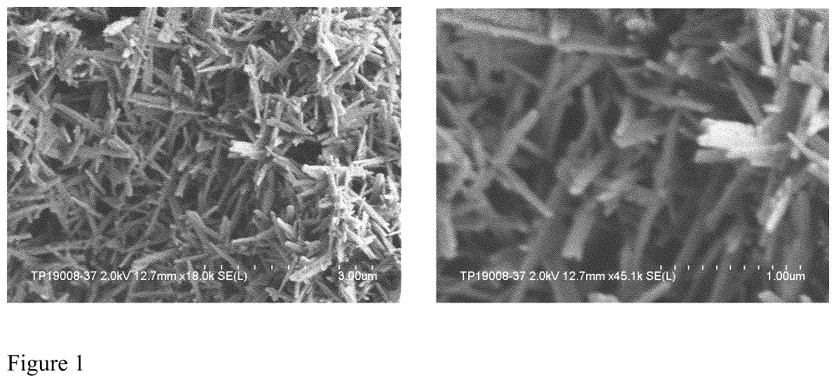

XRD analysis of the as-synthesized and calcined materials showed the material to have similar powder XRD patterns to respectively as-synthesized and calcined SSZ-64 in terms of degree 2-theta and d-spacing but with different relative intensities (as illustrated in Tables I/IA and II/IIA of WO 2004/013042 A1). This new product was identified as EMM-70. FIG. 1 shows SEM images of the as-synthesized product. The exact structure of EMM-70 is unknown.

The micropore surface area (S_{micro}) of the calcined version of the EMM-70 material was 505 m²/g, its external surface area (Sₑₓₜ) was 63 m²/g, and its micropore volume (V_{micro}) was 0.18 cc/g.

### Example 3: SDA-1, USY Zeolite, Si/Al=15

This Example was conducted in the same conditions as Example 2 except that the synthesis mixture contained a higher amount of SDA-1 and a lower amount of NaOH, resulting in the following composition in terms of molar ratios:

25H₂O:1SiO₂:0.033Al₂O₃:0.40QOH:0.05NaOH.

After 4 weeks of heating at 160 °C, pure EMM-70 product was obtained, as identified by its XRD pattern.

### Comparative Example 4: SDA-1, USY Zeolite, Si/Al=30

This Example was conducted in the same conditions as Example 1, except that USY zeolite with a Si/Al molar ratio of 30 (available from Zeolyst as CBV760) was used as Si and Al source, resulting in a Si/Al molar ratio of 30 in the synthesis mixture. After 4 weeks of heating at 160 °C, no EMM-70 was obtained. The resulting product was identified as ITQ-27 based on its XRD pattern, as disclosed in J. E. Schmidt et al. (2016) Chem. Eur. J., v.22, pp. 4022-4029, or WO 2006/055305 A2.

### Example 5: SDA-2, USY Zeolite, Si/Al=15

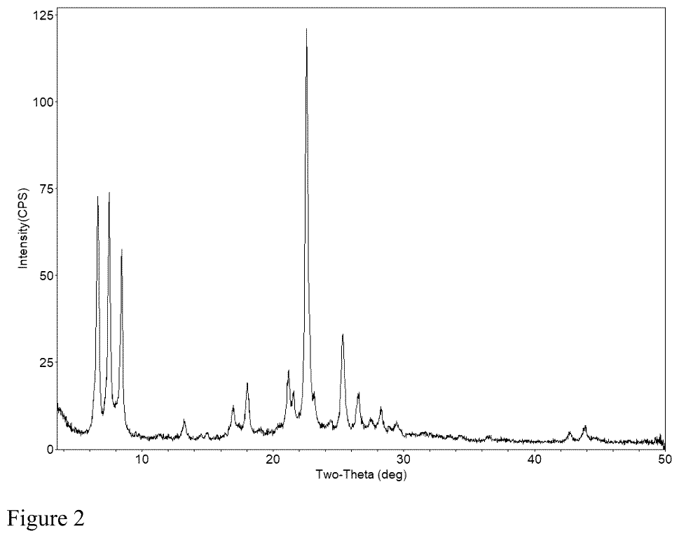

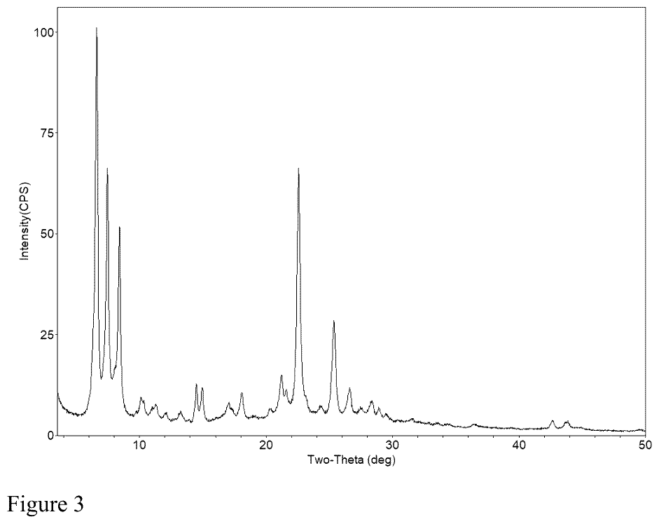

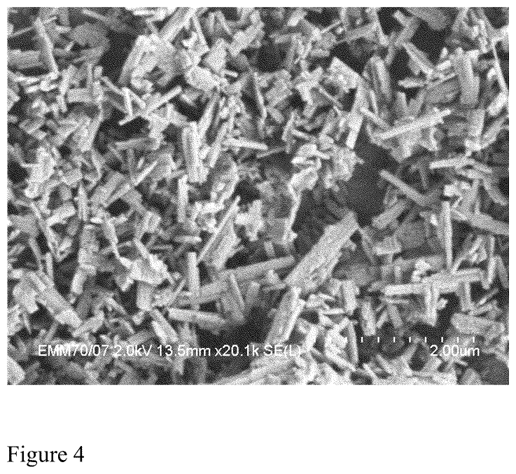

This Example was conducted in the same conditions as Example 1, except that SDA-1 was replaced with SDA-2, with a Q/Si molar ratio of 0.25 rather than 0.23. After 4 weeks of heating at 160 °C, pure EMM-70 product was obtained, as identified by its XRD pattern. FIGS. 2 and 3 show the powder XRD patterns of the as-synthesized and calcined products of Example 5. Tables 4 and 5 below show the list of peaks and intensities for the as-synthesized and calcined EMM-70 products of Example 5. FIG. 4 shows a SEM image of the as-synthesized product of Example 5.

### Example 6: SDA-2, USY Zeolite, Si/Al=15

This Example was conducted in the same conditions as Example 5 except that the synthesis mixture contained varying amounts of SDA-2, NaOH and water, resulting in the following composition in terms of molar ratios:

30H₂O:1SiO_{2:0.033}Al₂O_{3:0.20}QOH:0.10NaOH.

After 5 weeks of heating at 160 °C, EMM-70 product with a minor amount of ITQ-27 was obtained, as identified by its XRD pattern.

### Example 7: SDA-2, Colloidal Silica, Sodium Aluminate, Si/Al=15

This Example was conducted in the same conditions as Example 6 except that Ludox HS40 (40 wt % colloidal silica suspension) was used as the Si source and sodium aluminate (NaAlO₂, 25 wt % Al₂O₃, 19.3 wt % Na₂O) was used as the Al source. NaOH was also present in a slightly higher Na/Si molar ratio of 0.15. After 5 weeks of heating at 160 °C, EMM-70 product with a minor amount of ITQ-27 was obtained, as identified by its XRD pattern.

### Example 8: SDA-2, USY Zeolite, Si/Al=15

This Example was conducted in the same conditions as Example 5 except that the synthesis mixture contained a higher amount of SDA-2 and was conducted in the absence of NaOH, resulting in the following composition in terms of molar ratios:

25H₂O:1SiO_{2:0.033}Al₂O_{3:0.35}QOH.

After 3 weeks of heating at 160 °C, EMM-70 product with an undissolved faujasite zeolite phase was obtained, as identified by its XRD pattern.

TABLE 3

| | Si | Al | | Si/ | H2O/ | Q/ | OH/ | M/ | T | t | |
|---|---|---|---|---|---|---|---|---|---|---|---|
| Ex | Source | Source | SDA | Al | Si | Si | Si | Si | (°C) | (weeks) | Product |
| 2 | USY | USY | SDA- | 15 | 25 | 0.23 | 0.3 | 0.07 | 160 | 6 | EMM-70 |
| | (Si/Al = | (Si/Al = | 1* | | | | | | | | |
| | 15) | 15) | | | | | | | | | |
| 3 | USY | USY | SDA- | 15 | 25 | 0.4 | 0.45 | 0.05 | 160 | 4 | EMM-70 |
| | (Si/Al = | (Si/Al = | 1* | | | | | | | | |
| | 15) | 15) | | | | | | | | | |
| 4 | USY | USY | SDA- | 30 | 25 | 0.23 | 0.3 | 0.07 | 160 | 4 | ITQ-27 |
| | (Si/Al = | (Si/Al = | 1* | | | | | | | | |
| | 30) | 30) | | | | | | | | | |
| 5 | USY | USY | SDA- | 15 | 25 | 0.25 | 0.32 | 0.07 | 160 | 4 | EMM-70 |
| | (Si/Al = | (Si/Al = | 2** | | | | | | | | |
| | 15) | 15) | | | | | | | | | |
| 6 | USY | USY | SDA- | 15 | 30 | 0.2 | 0.3 | 0.1 | 160 | 5 | EMM-70 + |
| | (Si/Al = | (Si/Al = | 2** | | | | | | | | ITQ-27 |
| | 15) | 15) | | | | | | | | | |
| 7 | Ludox | NaAlO2 | SDA- | 15 | 30 | 0.2 | 0.35 | 0.15 | 160 | 5 | EMM-70 + |
| | HS40 | | 2** | | | | | | | | ITQ-27 |
| 8 | USY | USY | SDA- | 15 | 25 | 0.35 | 0.35 | 0 | 170 | 3 | EMM-70 + |
| | (Si/Al = | (Si/Al = | 2** | | | | | | | | FAU |
| | 15) | 15) | | | | | | | | | |

*SDA-1 = 1,2,3-trimethyl-4,5,6,7-tetrahydro-1H-benzo[d]imidazol-3-ium cation
**SDA-2 = 2-ethyl-1,3-dimethyl-4,5,6,7-tetrahydro-1H-benzo[d]imidazol-3-ium cation

TABLE 4

| Degree | d-spacing | Relative intensity |
|---|---|---|
| 2-theta | (Å) | [100 × I/(Io)] |
| 6.64 | 13.31 | 56.9 |
| 7.49 | 11.79 | 55.4 |
| 8.45 | 10.45 | 40.1 |
| 13.22 | 6.69 | 5.2 |
| 14.51 | 6.10 | 1.3 |
| 14.99 | 5.90 | 1.7 |
| 16.98 | 5.22 | 6.8 |
| 18.05 | 4.91 | 12.0 |
| 21.22 | 4.18 | 13.2 |
| 21.56 | 4.12 | 6.4 |
| 22.58 | 3.93 | 100 |
| 23.16 | 3.84 | 7.0 |
| 24.44 | 3.64 | 1.9 |
| 25.36 | 3.51 | 24.1 |
| 26.54 | 3.36 | 8.6 |
| 27.50 | 3.24 | 2.4 |
| 28.29 | 3.15 | 5.6 |
| 29.47 | 3.03 | 2.9 |

TABLE 5

| Degree | d-spacing | Relative intensity |
|---|---|---|
| 2-theta | (Å) | [100 × I/(Io)] |
| 6.64 | 13.30 | 100 |
| 7.48 | 11.81 | 58.5 |
| 8.42 | 10.49 | 42.2 |
| 10.13 | 8.72 | 5.0 |
| 11.29 | 7.83 | 3.0 |
| 12.10 | 7.31 | 1.8 |
| 13.28 | 6.66 | 2.8 |
| 14.52 | 6.10 | 10.5 |
| 14.97 | 5.91 | 9.3 |
| 17.08 | 5.19 | 4.0 |
| 18.11 | 4.89 | 6.6 |
| 21.22 | 4.18 | 8.5 |
| 22.60 | 3.93 | 66.5 |
| 25.38 | 3.51 | 25.6 |
| 26.61 | 3.35 | 6.5 |
| 28.36 | 3.14 | 3.5 |

While the present invention has been described and illustrated with reference to particular embodiments, it will be appreciated by those of ordinary skill in the art that the invention lends itself to many different alterations, modifications, and variations not specifically illustrated herein. It will also be apparent to those skilled in the art that when numerical lower limits and numerical upper limits are listed herein, ranges from any lower limit to any upper limit are contemplated. Also, all numerical values within the detailed description herein are modified by “about” the indicated value, and take into account experimental error and variations that would be expected by a person having ordinary skill in the art.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

Additionally or alternately, the invention relates to:

Embodiment 1: A zeolite having, in its calcined form, an X-ray diffraction pattern including the peaks or Table 1 or 1A.

Embodiment 2: The zeolite of embodiment 1, having a molecular formula of Formula II:

(m)X₂O₃:YO₂ (Formula II),

wherein 0.017<m≤0.1, X is a trivalent element, and Y is a tetravalent element.

Embodiment 3: The zeolite of embodiment 2, wherein X comprises one or more of aluminum and boron, preferably X is selected from the group consisting of aluminum, boron and combinations thereof, more preferably X comprises or is aluminum.

Embodiment 4: The zeolite of embodiment 2 or 3, wherein Y comprises one or more of silicon and germanium, preferably Y is selected from the group consisting of silicon, germanium and combinations thereof, more preferably Y comprises or is silicon.

Embodiment 5: A zeolite having, in its as-synthesized form, an X-ray diffraction pattern including the peaks of Table 2 or 2A.

Embodiment 6: The zeolite of embodiment 5, having a molecular formula of Formula III:

(q)Q:(m)X₂O₃:YO₂ (Formula III),

wherein 0≤q≤0.5; 0.017<m≤0.1; Q comprises at least one cation selected from 4,5,6,7-tetrahydrobenzimidazolium cations of Formula I:

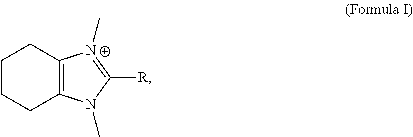

where R is methyl or ethyl; X is a trivalent element, and Y is a tetravalent element.

Embodiment 7: The zeolite of embodiment 6, wherein X comprises one or more of aluminum and boron, preferably X is selected from the group consisting of aluminum, boron and combinations thereof, more preferably X comprises or is aluminum.

Embodiment 8: The zeolite of embodiment 6 or 7, wherein Y comprises one or more of silicon and germanium, preferably Y is selected from the group consisting of silicon, germanium and combinations thereof, more preferably Y comprises or is silicon.

Embodiment 9: The zeolite of any one of embodiments 6 to 7, wherein the structure directing agent (Q) comprises at least one cation selected from the group consisting of 1,2,3-trimethyl-4,5,6,7-tetrahydrobenzimidazolium cation, 2-ethyl-1,3-dimethyl-4,5,6,7-tetrahydrobenzimidazolium cation, and mixtures thereof.

Embodiment 10: The zeolite of any one of embodiments 1 to 9, which is an aluminosilicate or a borosilicate and which has a Si/Al or Si/B molar ratio of less than 30, preferably from 5 to 25, more preferably from 10 to 25.

Embodiment 11: A method of making the zeolite of any one of embodiments 1 to 10, comprising:
(a) preparing a synthesis mixture comprising water, a source of an oxide of tetravalent element (Y), a source of an oxide of trivalent element (X), a structure directing agent (Q), optionally a source of hydroxide ions (OH), and optionally a source of alkali and/or alkaline earth metal element (M),
   wherein the structure directing agent (Q) comprises at least one cation selected from 4,5,6,7-tetrahydrobenzimidazolium cations of Formula I:

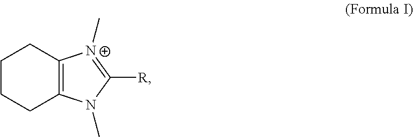

where R is methyl or ethyl,
wherein the synthesis mixture has a Y/X molar ratio of less than 30 and, if a source of fluoride (F) is present, a F/Y molar ratio of less than 0.05;
(b) heating said synthesis mixture under crystallization conditions including a temperature of from 100 °C to 200 °C for a time sufficient to form crystals of said zeolite;
(c) recovering at least a portion of the zeolite from step (b); and
(d) optionally treating the zeolite recovered in step (c) to remove at least part of the structure directing agent (Q).

Embodiment 12: The method of embodiment 11, wherein the structure directing agent (Q) comprises at least one cation selected from the group consisting of 1,2,3-trimethyl-4,5,6,7-tetrahydrobenzimidazolium cation, 2-ethyl-1,3-dimethyl-4,5,6,7-tetrahydrobenzimidazolium cation, and mixtures thereof.

Embodiment 13: The method of embodiment 11 or 12, wherein the structure directing agent (Q) is in the form of a halide, hydroxide or nitrate, preferably wherein the structure directing agent (Q) is in its hydroxide form.

Embodiment 14: The method of any one of embodiments 11 to 13, wherein the trivalent element X comprises one or more of aluminum and boron, preferably X is selected from the group consisting of aluminum, boron and combinations thereof, more preferably X comprises or is aluminum, and the tetravalent element Y comprises one or more of silicon and germanium, preferably Y is selected from the group consisting of silicon, germanium and combinations thereof, more preferably Y comprises or is silicon.

Embodiment 15: The method of any one of embodiments 11 to 14, wherein the synthesis mixture has the following composition in terms of molar ratios:

| Molar | Typical | Preferred | More preferred |
|---|---|---|---|
| ratios | range | range | range |
| Y/X | 1-<30 | 5-25 | 5-20 |
| Q/Y | 0.05-1.0 | 0.1-0.8 | 0.15-0.5 |
| OH/Y | 0-1.0 | 0.05-0.8 | 0.15-0.5 |
| | | (if OH present) | (if OH present) |
| M/Y | 0-1.0 | 0.05-0.5 | 0.05-<0.1 |
| | | (if M present) | (if M present) |
| H₂O/Y | 1-100 | 10-80 | 15-50 |

Embodiment 16: The method of any one of embodiments 11 to 15, wherein the synthesis mixture comprises a source of fluoride (F) in a F/Y molar ratio of from 0 to 0.02, more preferably from 0 to 0.01, most preferably wherein the synthesis mixture is substantially free of fluoride (F) ions.

Embodiment 17: A process of converting an organic compound to a conversion product comprises contacting the organic compound with the zeolite of any one of embodiments 1 to 10.

1. A zeolite having, in its calcined form, an X-ray diffraction pattern including the following peaks in Table 1:
TABLE 1

| degree 2-theta | relative intensity |
|---|---|
| (±0.20) | [100 × I/(Io)] |
| 6.64 | 60-100 |
| 7.48 | 50-70 |
| 8.42 | 40-60 |
| 14.52 | 5-15 |
| 14.97 | 5-15 |
| 21.22 | 5-15 |
| 22.60 | 60-80 |
| 25.38 | 20-30 |
| 26.61 | 0-10 |
| 28.36 | 0-5 |

2. The zeolite of claim 1 having a molecular formula of Formula II:
(m)X₂O₃:YO₂ (Formula II),
wherein 0.017<m≤0.1, X is a trivalent element, and Y is a tetravalent element.

3. The zeolite of claim 2, wherein X comprises one or more of aluminum and boron, and Y comprises one or more of silicon and germanium.

4. The zeolite of claim 2, wherein X comprises aluminum and Y comprises silicon.

5. The zeolite of claim 2, which is an aluminosilicate or a borosilicate and which has a Si/Al or Si/B molar ratio of less than 30.

6. A zeolite having, in its as-synthesized form, an X-ray diffraction pattern including the following peaks in Table 2:
TABLE 2

| Degree 2-theta | Relative intensity |
|---|---|
| (±0.20) | [100 × I/(Io)] |
| 6.64 | 50-70 |
| 7.49 | 50-70 |
| 8.45 | 30-50 |
| 18.05 | 5-15 |
| 21.22 | 5-15 |
| 21.56 | 0-10 |
| 22.58 | 60-100 |
| 25.36 | 20-30 |
| 26.54 | 5-15 |

7. The zeolite of claim 6 having a molecular formula of Formula III:
(q)Q:(m)X₂O₃:YO₂ (Formula III),
wherein 0≤q≤0.5; 0.017<m≤0.1; Q comprises at least one cation selected from 4,5,6,7-tetrahydrobenzimidazolium cations of Formula I: 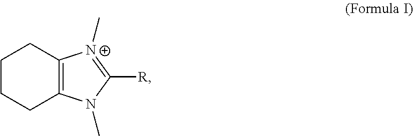
where R is methyl or ethyl; X is a trivalent element, and Y is a tetravalent element.

8. The zeolite of claim 7, wherein X comprises one or more of aluminum and boron, and Y comprises one or more of silicon and germanium.

9. The zeolite of claim 7, wherein X comprises aluminum and Y comprises silicon.

10. The zeolite of claim 7, wherein the structure directing agent (Q) comprises at least one cation selected from the group consisting of 1,2,3-trimethyl-4,5,6,7-tetrahydrobenzimidazolium cation, 2-ethyl-1,3-dimethyl-4,5,6,7-tetrahydrobenzimidazolium cation, and mixtures thereof.

11. The zeolite of claim 7, which is an aluminosilicate or a borosilicate and which has a Si/Al or Si/B molar ratio of less than 30.

12. A method of making the zeolite of claim 1, comprising:
(a) preparing a synthesis mixture comprising water, a source of an oxide of tetravalent element (Y), a source of an oxide of trivalent element (X), a structure directing agent (Q), optionally a source of hydroxide ions (OH), and optionally a source of alkali and/or alkaline earth metal element (M),
wherein the structure directing agent (Q) comprises at least one cation selected from 4,5,6,7-tetrahydrobenzimidazolium cations of Formula I: 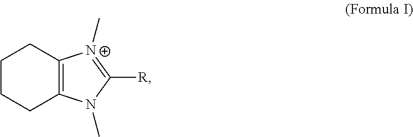
where R is methyl or ethyl,
wherein the synthesis mixture has a Y/X molar ratio of less than 30 and, if a source of fluoride (F) is present, a F/Y molar ratio of less than 0.05;
(b) heating said synthesis mixture under crystallization conditions including a temperature of from 100 °C to 200 °C for a time sufficient to form crystals of said zeolite;
(c) recovering at least a portion of the zeolite from step (b); and
(d) optionally treating the zeolite recovered in step (c) to remove at least part of the structure directing agent (Q).

13. The method of claim 12, wherein the structure directing agent (Q) comprises at least one cation selected from the group consisting of 1,2,3-trimethyl-4,5,6,7-tetrahydrobenzimidazolium cation, 2-ethyl-1,3-dimethyl-4,5,6,7-tetrahydrobenzimidazolium cation, and mixtures thereof.

14. The method of claim 12, wherein the structure directing agent (Q) is in the form of a halide, hydroxide or nitrate.

15. The method of claim 12, wherein the trivalent element X is selected from the group consisting of aluminum, boron and combinations thereof, and the tetravalent element Y is selected from the group consisting of silicon, germanium and combinations thereof.

16. The method of claim 12, wherein X comprises aluminum and Y comprises silicon.

17. The method of claim 12, wherein the synthesis mixture has the following composition in terms of molar ratios:

| Molar ratios | Range |
|---|---|
| Y/X | 1-30 |
| Q/Y | 0.05-1.0 |
| OH/Y | 0-1.0 |
| M/Y | 0-1.0 |
| H₂O/Y | 1-100 |

18. The method of claim 12, wherein the synthesis mixture has the following composition in terms of molar ratios:

| Molar ratios | Range |
|---|---|
| Y/X | 5-25 |
| Q/Y | 0.1-0.8 |
| OH/Y | 0.05-0.8 |
| | (if OH present) |
| M/Y | 0.05-0.5 |
| | (if M present) |
| H₂O/Y | 10-80 |

19. The method of claim 12, wherein the synthesis mixture comprises a source of fluoride (F) in a F/Y molar ratio of from 0 to 0.01.

20. A process of converting an organic compound to a conversion product, the process comprising contacting the organic compound with the zeolite of claim 1.
